(19) United States
(12) Patent Application Publication
(10) Pub. No.: US 2011/0132109 A1
(43) Pub. Date: Jun. 9, 2011

(54) DEVICE AND PROCESS FOR THE FORMATION OF MICRODEPOSITIONS

(75) Inventor: Michel Delaage, Marseille (FR)

(73) Assignee: DIOSCURE, Marseille (FR)

(21) Appl. No.: 12/936,959

(22) PCT Filed: Apr. 9, 2009
(86) PCT No.: PCT/FR09/50631

§ 371 Date: Dec. 27, 2010

(30) Foreign Application Priority Data
Apr. 11, 2008 (FR) 0852466

(51) Int. Cl. B01L 3/02

(52) U.S. Cl. 73/863.32

(57) ABSTRACT

Methods and equipment for forming multiple micro-depositions on surfaces from a single sample for sample analysis are provided. The device for the formation of micro-depositions of a liquid sample, includes a plurality of reservoirs, each with a through-hole, and needles, each with a tip mounted for movement through and beyond the hole, and a control member ensuring the controlled and regular formation of micro-depositions according to a defined profile.

### BACKGROUND INFORMATION

The present invention concerns the analysis of samples, and in particular methods and apparatus for forming multiple micro-deposits of a sample on surfaces. The invention more specifically concerns a device for forming micro-deposits of a liquid sample, comprising a plurality of reservoirs and needles, ensuring controlled and regular micro-depositing according to a defined pattern.

### TECHNOLOGICAL BACKGROUND OF THE INVENTION

The possible conducting of several hundred multiplexed analyses of one same sample, using micro-deposits of reagents on planar surfaces, is currently widely proven. Analysis of the gene expression of one same sample notably has recourse to the micro-depositing of nucleotide sequences. The micro-depositing of antigens is also used to determine the antibodies of subjects having infection or vaccination status in the field of immunochemistry.

The multiplexed analysis of samples is currently restricted to the field of research owing to the cost and slow process of micro-deposition methods. However, said multiplexed analysis offers numerous applications in the field of diagnosis. It is particularly useful in that it enables one sample to be subjected to several reagents. In addition, one same reagent must frequently be applied to a large number of separate samples.

Depositing techniques have been designed for the formation of DNA chips. A DNA chip is a small plate in glass, silicon or plastic, on which nucleic sequences are deposited that are characteristic of certain genes and which, by matching with complementary nucleic sequences in a mixture of molecules, allow the presence of the same genes to be detected in the cells subjected to analysis.

However, on account of their very high cost and low production rate, these techniques cannot be transposed to large-scale diagnosis applications.

Apparatus for the fabrication of DNA chips has been described for example in patent application EP 1618948. This apparatus comprises a working table with supports, means to store a solution and means to sample a solution and to deposit it on these supports. This document does not describe equipment comprising a plurality of reservoirs and needles as well as a raising-lowering device allowing the entry of the needles into the wells in a perpendicular direction, to form micro-deposits of a liquid sample.

Other micro-deposition machines are known for the preparation of DNA chips. These machines are designed to form deposit spots or sample spots on microscope slides. A certain number of glass slides of microscope format (25×75 mm) are placed on a carrier. The solutions to be deposited are contained in a plate with alveoli forming a reservoir. A deposit head aspirates the solutions from the alveolar plate. The deposit head moves over the slides to deposit the solutions thereupon and is driven by very precise X, Y, Z mechanics.

These machines are optimized to deposit a large number of different spots on a reduced number of slides. However, there is much wastage of solutions to be deposited since the re-use frequency of the deposit head entails numerous rinsing operations. In addition, these machines are incapable of forming deposits on diagnosis plates. A standard diagnosis plate comprises 96 wells distributed over eight rows and 12 columns with a pitch of 9 mm and depth of 8 mm, which makes deposition impossible with current machines.

In particular, Genetic Microsystems manufactures a deposit machine under the reference Arrayer 417. This machine uses <<pin and ring>> type technology. Only this technology is currently capable of depositing bacterial suspensions without any clogging. It led to patent U.S. Pat. No. 6,269,846 relating to pin guidance.

It is ascertained in practice that deposit size varies in relation to the position of the slide. Also decanting and evaporation of the solution to be deposited are not controlled, which leads to its varying concentration. This machine performs repeated washings of the deposit head, which, in practice, entails a loss in the order of 95% of the solution to be deposited.

The invention sets out to solve one or more of these problems. The invention effectively provides methods and apparatus allowing the micro-depositing of a sample on a suitable support in stable, reproducible and reliable manner. The invention notably allows to carry out large series of micro-deposits and it can be applied to any type of sample.

### SUMMARY OF THE INVENTION

The present invention concerns a device for forming micro-deposits of a liquid sample onto a support (or onto a surface), comprising a plurality of needles and reservoirs.

More particularly, the invention relates to a device for forming micro-deposits of a liquid sample, characterized in that it comprises:
a reservoir intended to receive a liquid sample to be deposited, the bottom of the reservoir being provided with a through-hole, the hole being sized to hold the sample in the reservoir under capillarity;
a needle having a mobile-mounted tip, mobile as far as a position in which it passes through the hole to protrude outwardly from the reservoir and carry a fraction of the sample outside the reservoir; and
a control member controlling the movement of the tip as far as said position.

The invention advantageously concerns a device for forming micro-deposits of a liquid sample on a support, characterized in that it comprises:
a plurality of reservoirs 11 intended to receive a liquid sample 12 to be deposited, the bottom of each reservoir being provided with a through-hole, the hole being sized to hold the sample in the reservoir under capillarity;
a plurality of needles 3, each needle being associated with a reservoir and having a tip 34 mounted mobile as far as a position in which it passes through the hole and protrudes outwardly from the associated reservoir 11 carrying a fraction of the sample outside the reservoir; and
a control member 5—controlling the movement of the tip as far as said position.

According to one particularly preferred variant, the device further comprises:
a support 91 (e.g. a plate) in which wells 92 are arranged; and
the control member comprises a raising-lowering device enabling the needles to enter into the wells 92;
   said plurality of needles and the support 91 being subjected to relative perpendicular movements.

In one most preferred embodiment of the device of the invention, said plurality of reservoirs and needles is arranged to reproduce the pattern of the micro-deposits to be formed, during the movement of the support or of the plurality of needles.

In preferred embodiments, the device of the invention further comprises one or more of the following characteristics:
the tip 34 is mounted mobile between a position in which it is housed inside the reservoir and said position in which it protrudes outwardly from the reservoir;
the hole is of circular shape and has a diameter of between 0.3 and 0.6 mm;
the tip 34 has a diameter of between 0.10 mm and 0.3 mm;
the tip has several successive parts of increasing sections starting from the free end of the tip 34;
the reservoir 11 has a capacity comprised between 5 and 100 microlitres, preferably between 5 and 50 microlitres;
the reservoir has a cylindrical bore in its upper part 13 and a conical bore in its lower part 14 joining the cylindrical bore to the through-hole;
the outer part of the reservoir surrounding the through-hole is coated with a hydrophobic coating;
the weight of the needle 3 drives the tip towards the position in which it protrudes outwardly from the reservoir, and the control member comprises a motor 52 and a lever 53 actuated by the motor driving the needle towards the position in which the tip 34 is housed inside the reservoir;
the device comprises several associated reservoirs and needles, the reservoirs being separated by one same pitch. The lever drives the tips of said needles towards the position in which these tips are housed inside their associated reservoirs;
the reservoirs are arranged in one same single-piece component 1;
the device comprises a guide 2 and the needle comprises a body 32,33 projecting beyond and joined to the tip, the body being guided in translation by the guide 2;
the guide 2 is joined to the reservoir 11;
the reservoir 11 has an outer wall of cylindrical shape screwed into a lower bore of the guide 2;
the guide forms a shoulder 23 projecting radially beyond the outer wall of the reservoir 11;
the device comprises a plurality of needles grouped together in chequered fashion reproducing the pattern of the micro-deposits to be formed, a plate 91 in which wells 92 are arranged, a raising-lowering device allowing entry of the needles into the wells 92, the plurality of needles and the plate 91 being subjected to relative perpendicular movements;
the needle forms a bulge 35 projecting radially inside the guide 2 under the bearing 21; and/or
the device further comprises a member to place in position and remove a support directly under the tip 34.

A further object of the invention is a device comprising:
a conveyor conveying supports in a direction for treatment;
a loading device loading supports onto the conveyor;
a device for forming sample micro-deposits such as defined above, arranged directly above the supports placed on the conveyor downstream of the loading device, the device forming deposits on the supports in a manner synchronized with driving by the conveyor; and
an unloading device 87 unloading supports from the conveyor, arranged downstream of the device for forming micro-deposits.

A further object of the invention concerns a method for forming deposits of a liquid sample on a support, comprising the application of micro-deposits by means of a device such as defined above.

The invention also concerns the use of a device such as defined above for forming micro-deposits of one or more liquid samples on a support.

The invention further concerns a method for producing supports containing sample micro-deposits, the method comprising the application of the micro-deposits by means of a device such as defined above.

Other characteristics and advantages of the invention will become apparent from the description given below, by way of indication, which is in no way limiting, with reference to the appended drawings in which:

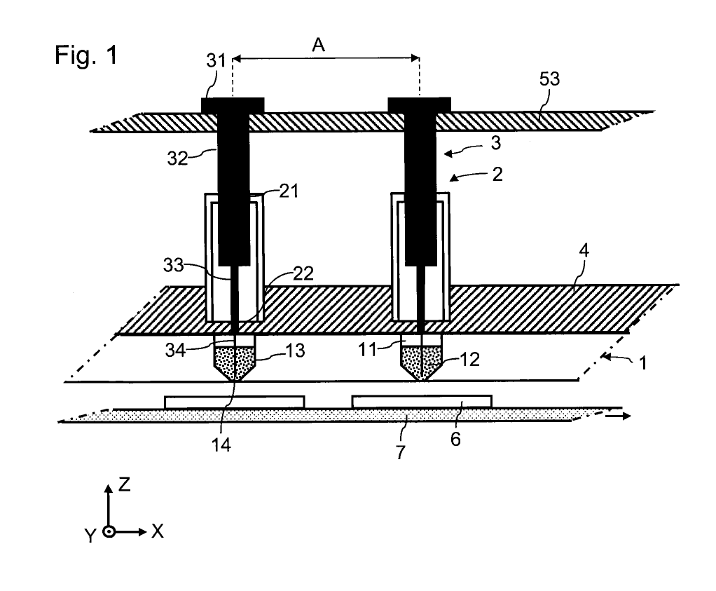

FIG. 1 is cross-sectional side view of a first embodiment of a micro-deposition machine;

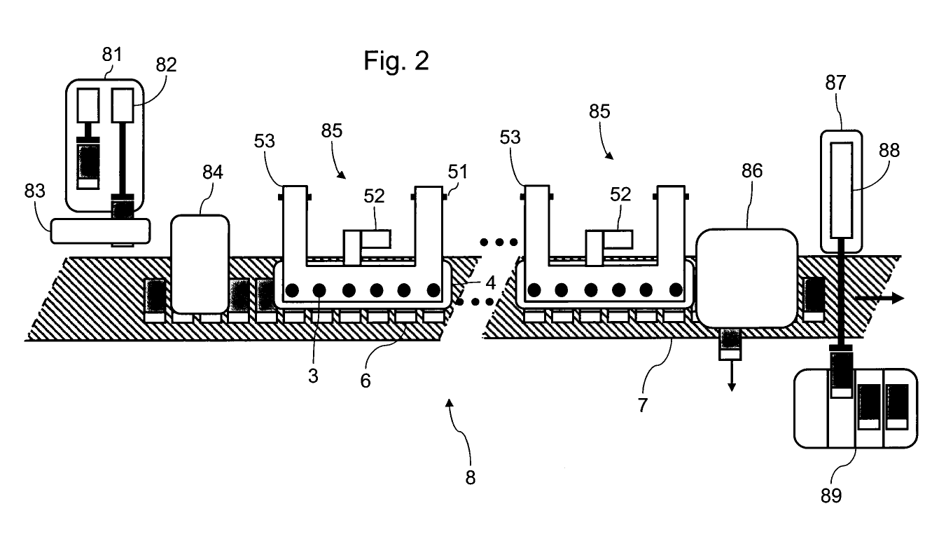

FIG. 2 is a schematic overhead view of a deposition line on glass slides, using the machine in FIG. 1;

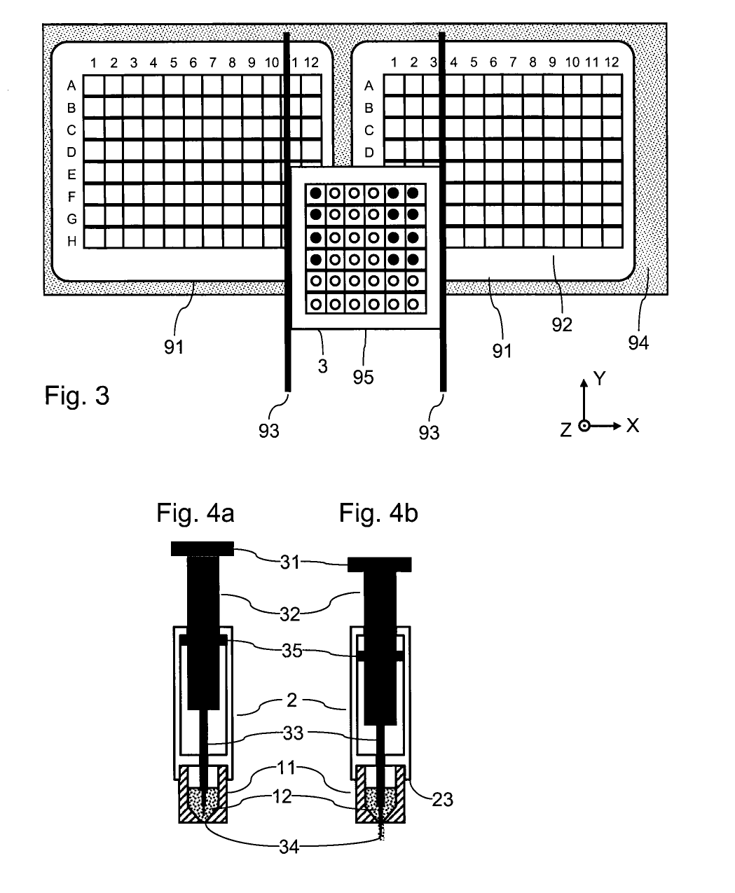

FIG. 3 is a schematic overhead view of a second embodiment of a micro-deposition machine in operation;

FIGS. 4A and 4B are cross-sectional side views of needles of the machine in FIG. 3, at different operating steps;

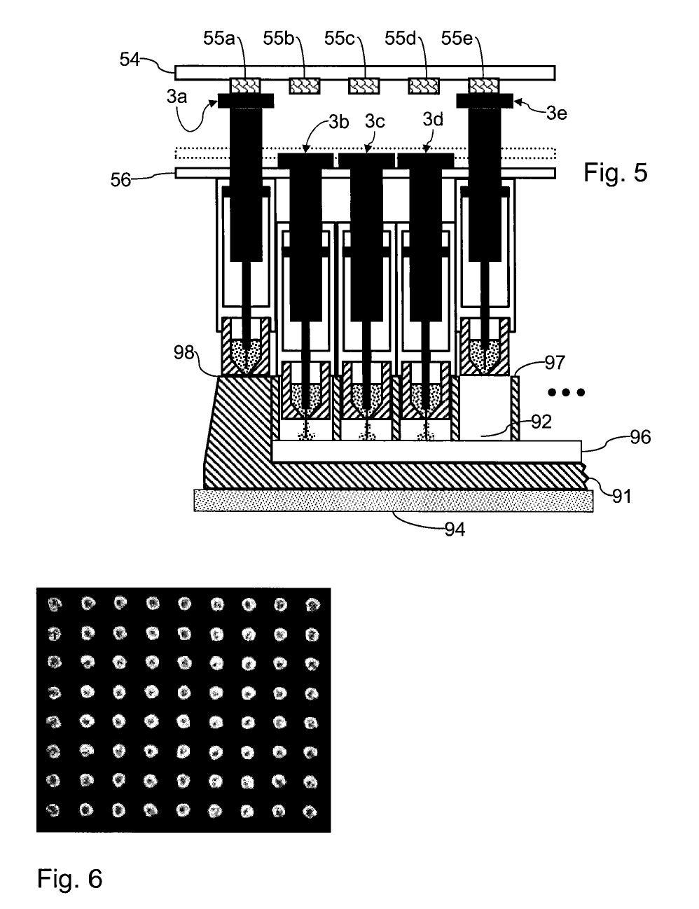

FIG. 5 is a cross-sectional view of the machine in FIG. 3 when in operation;

FIG. 6 is a florescence image of deposits made using a machine according to the invention.

### DETAILED DESCRIPTION OF THE INVENTION

The present application concerns methods and devices for forming micro-deposits (or spot deposits) of one or more samples on the surface of a suitable support. As will be described in more detail below, the invention can be applied to any type of liquid sample i.e. notably any solution or suspension e.g. aqueous. The sample can be of varied type, such as a sample of polypeptide type for example (peptides, polypeptides, proteins, antibodies, etc.) nucleic (DNA, RNA, etc.) cellular, viral, lipid, biological, etc. The invention allows the formation of micro-deposits i.e. deposits typically having a volume of less than 50 nl, typically between 0.01 and 10 nl, this quantity being adjustable by a skilled person.

The invention allows deposits to be formed on any type of suitable support. These are preferably supports comprising an essentially planar surface (such as a slide, a membrane, a filter, etc.). They may also be supports having one or more planar surfaces separated by partitions, or a planar surface in which alveoli are arranged e.g. a multi-well plate. The support may be in any adapted material (glass, plastic, any compatible polymer, metal, silica, ceramic, coral etc . . . . ) They are typically multi-well plates such as a 12-, 24- or 96-wells plate or more. They may also be glass slides.

According to one preferred embodiment, the device of the invention comprises:
a plurality of reservoirs 11 intended to receive a liquid sample 12 to be deposited, the bottom of each reservoir being provided with a through hole, the hole being sized to hold the sample in the reservoir under capillarity;
a plurality of needles 3, each needle being associated with a reservoir and having a tip 34 mounted mobile as far as a position in which it passes through the hole to protrude outwardly from the associated reservoir 11 and carry a fraction of the sample outside the reservoir; and
a control member 5—controlling the movement of the tip as far as said position, said plurality of reservoirs and needles being arranged so as to reproduce the pattern of micro-deposits to be formed, during the movement of the support or of the plurality of needles.

According to one particularly preferred embodiment, the device further comprises:
a support 91 (e.g. a plate) in which wells 92 are arranged; and
the control member comprises a raising-lowering device allowing entry of the needles into the wells 92;
   said plurality of needles and the support 91 being subjected to relative perpendicular movements.

The device may comprise a varied number of reservoirs and associated needles. Therefore the term plurality typically designates a number of between 2 and 50, preferably between 4 and 50 and preferably between 9 and 50. In particular examples, the device comprises 2, 4, 6, 8, 9, 12, 15, 25 or 36 reservoirs and associated needles.

Preferably, the reservoirs and needles are arranged in chequered fashion or in a predefined geometric array (e.g. a square or rectangular array) allowing reproduction of the profile of the micro-deposits and a line arrangement along a continuous industrial production line, leading to parallel maintaining of the alignment of conducted deposits by several remote devices. According to one particular embodiment, the reservoirs and needles have a chequered arrangement in a square array 6×6, 5×5, 4×4 or 3×3.

According to particular embodiments of the invention, the tip 34:
is mounted mobile between a position in which it is housed inside the reservoir and said position in which it protrudes outwardly from the reservoir, and/or
has a diameter of between 0.10 mm and 0.3 mm, and/or
has several successive parts of increasing sections starting from the free end of the tip 34.

According to one particular embodiment of the invention, the hole, provided to hold the sample in the reservoir, is of circular shape and has a diameter of between 0.3 and 0.6 mm.

The invention also concerns a device in which the reservoir 11 has a capacity of between 5 and 100 microlitres, preferably between 5 and 50 microlitres. The reservoir of the invention may have a cylindrical bore in its upper part 13, and a conical bore in its lower part 14 joining the cylindrical bore to the through-hole. The outer part of the reservoir surrounding the through-hole may be coated with a hydrophobic coating.

One particular aspect of the invention concerns a device in which the weight of the needle 3 drives the tip towards the position in which it protrudes outwardly from the reservoir, and in which the control member comprises a motor 52 and a lever 53 actuated by the motor driving the needle towards the position in which the tip 34 is housed inside the reservoir.

Another aspect concerns a device comprising several reservoirs and associated needles, the reservoirs being spaced from each other by one same pitch, the lever driving the tips of said needles towards the position in which these tips are housed inside their associated reservoirs. Preferably, the reservoirs are arranged in one same single-piece component 1.

A further object of the invention concerns a device comprising a guide 2 joined to the reservoir 11, device in which the needle comprises a body 32,33 projecting beyond and joined to the tip, the body being guided in translation by the guide 2. Said reservoir 11 can have an outer wall of cylindrical shape screwed into a lower bore of the guide 2 and said guide may form a shoulder 23 projecting radially beyond the outer wall of the reservoir 11.

One particular object of the invention concerns a device in which the needle forms a bulge 35 projecting radially inside the guide 2 under a bearing 21.

The device of the invention may further comprise a member to place and remove a support directly under the tip 34. Said device may also comprise:
a conveyor 7 conveying the supports 6 in a direction for treatment;
a loading device 81 loading supports 6 onto the conveyor 7;
a device for forming sample micro-deposits 85 such as defined previously, arranged vertically above the supports placed on the conveyor downstream of the loading device, the device forming deposits on the supports in a manner synchronized with driving by the conveyor; and
an unloading device 87 unloading supports from the conveyor, arranged downstream of the deposit forming device.

According to other embodiments of the invention, the device of the invention, instead of the reservoirs and needles, may be equipped with a plurality of conventional heads of pipette type expelling droplets by piezo-electric constriction (for example “Piezoarray” by Perkin-Elmer) or by micro-boiling (for example according to the method described in U.S. Pat. No. 5,551,883), arranged as described above.

A further object of the invention concerns methods for the formation of deposits of a liquid sample on a support, which comprise the application of deposits by means of a device according to the invention.

As indicated above, the invention concerns devices for the formation of deposits from a liquid sample (e.g. an aqueous solution) contained in a reservoir. One characteristic of the devices of the invention lies in the fact that a through-hole is arranged in the bottom of the reservoir, the hole being sized to hold the liquid sample in the reservoir under capillarity. The device comprises a needle tip capable of carrying the sample through the hole.

The deposit formation device illustrated FIG. 1 comprises a conveyor belt 7, conveying glass slides 6. The successive slides 6 are arranged on the belt 7 at a predefined pitch, e.g. 35 mm. The slides 6 may for example be positioned along X and Y by means of a template. Two perpendicular sides of a slide 6 are in contact with two respective sides of a template. The belt 7 drives the slides in direction X. The device comprises a plate 1 positioned over the belt 7. Several reservoirs 11 are arranged in the plate 1 and have a through-hole in their bottom part. These reservoirs 11 are filled with solutions 12 to be deposited in the form of deposits. Each hole is sized to hold the solution in the reservoir 11 under capillarity. The reservoirs typically have a capacity of between 5 and 100 microlitres, preferably between 5 and 50 microlitres, even if this capacity can be adapted by a skilled person, and may vary from one reservoir to another. Overhead the plate 1 there is a cover plate 4 which acts as lid and guide. The cover plate 4 is removably attached to the plate 1, for example to carry out maintenance operations for example or to facilitate filling of the reservoirs 11. The cover plate 4 has threaded bores arranged directly above respective reservoirs 11 of the plate 1. Guide supports 2 are fixed in the bores of the cover plate 4. Needles 3 are guided in translation along axis Z by the guide support 2. The needles 3 have a tip 34 at their lower end arranged inside a respective reservoir 11 in the illustrated position. The device also comprises a lever 53 defining the translation stroke of the tip 34.

By lowering the tip 34 in direction Z, this tip drives a fraction of the solution 12 in the reservoir 11 through the through-hole, to deposit this fraction on the glass slide 6 lying vertically underneath.

With the invention, it is possible to perform a large number of deposits at high speed from the solution 12 present in the reservoir 11, by limiting the evaporation of this solution 12. In addition, the tip 34 forms a piston passing through the hole of the reservoir 11 and prevents clogging thereof. The tip 34 guarantees extensive reproducibility of the formed deposits. Also, throughout the entire process of deposit formation, the solutions and the needles 3 are insulated from the outside which eliminates risks of contamination.

The plate 1 has several reservoirs 11 intended to receive solutions 12 to be deposited on the glass slides 6. These reservoirs 11 may be fabricated by machining one same metal plate. The reservoirs 11 are arranged at a pitch corresponding to the pitches between the successive slides 6 on the belt 7.

Advantageously, the reservoirs 11 and the belt 7 can be moved relative to one another along direction Y, so as to form several deposits as per the largest dimension of a glass slide 6. The plate 1 may notably be motorized so that it can be moved along axes X and Y relative to the belt 7. Glass slides 6 each having up to 18 deposit regions surrounded by hydrophobic delimitations can be used.

A bore is arranged in each reservoir 11 and has an upper part 13 of cylindrical shape, and a lower part 14 of conical shape forming the bottom of the reservoir 11. The through-hole is formed in the lower part 14. The reservoir 11 may typically have a height of several millimetres, for example between 2 and 4 millimetres. The upper part 13 may have a diameter of several millimetres. The through-hole arranged in the lower part 14 advantageously has a diameter of between 0.3 and 0.6 millimetres. Said diameter is sufficient to allow the passing of particles present in the solution 12. For most solutions to be deposited, said diameter of the hole allows the solution 12 to be held in the reservoir 11 without flowing out, due to capillary forces. It is therefore not necessary to have recourse to a complex mechanism to retain the solution. To strengthen the capillary force on the solution 12, the lower part 14 of the reservoir 11 is advantageously coated with a hydrophobic coating, e.g. silicon or polytetrafluoroethylene.

The guide support 2 is fabricated in the form of a hollow cylinder. It supports the upper and lower guide bearings of a needle, which are either block machined or formed of added rings. The guide support is joined to the reservoir.

In one particular embodiment, the lower part of the guide support is tapped and the reservoir is threaded. This embodiment is particularly adapted to the formation of micro-deposits on multiwell plates, for example 96-well plates. With this type of support, it is advantageous that the reservoir should be able to move heightwise so that it can enter the well, which is achieved for example by suspending it to the needle.

In another embodiment, the outer surface of the lower part of the guide support 2 is threaded and the reservoir is surmounted by a tapped bore.

In another embodiment, advantageous for associating several reservoirs, the lower part of the guide support is screwed into the corresponding tapped bore of the cover plate 4.

The radial positioning and the guiding in translation of the needle 3 are ensured via the upper bearing 21 arranged in the guide support and via the lower bearing 22 arranged in the cover plate 4. The upper bearing 21 is made in a shoulder arranged in the upper part of the guide support 2. The lower bearing 22 is made in a shoulder arranged in the bottom of a tapped bore of the cover plate 4. It could also be envisaged to arrange the lower bearing 22 in the guide support 2. This shoulder also forms a cover for the reservoir 11. The upper 21 and lower 22 bearings are separated by a distance of about 20 mm. The lower and upper bearings may be provided with a cylindrical ring in polytetrafluoroethylene.

The needle 3 has a tip 34 dipped in the solution 12 and whose lower end is intended to bring a fraction of this solution into contact with the glass slide 6. The tip 34 advantageously has a diameter of between 0.1 and 0.3 mm. The lower end of the tip 34 is preferably polished. The tip 34 is surmounted by a first part of the translational guiding 33. The tip 34 may have a section increasing between its free end and its junction with the first guide part 33, to increase agitation of the solution 12 and thereby ensure the homogeneity of this solution for the different deposits to be made. The tip 34 may also have several sections of different diameters and increasing starting from the free end as far as the first guide part 33. The tip may notably have a section with a diameter of 0.3 mm joining the free end to the first guide part 33. This guide part 33 has a diameter of about 1 mm and is mounted slidingly to adjust to the bearing 22. The first guide part 33 is surmounted by a second translational guide part 32. The guide part 32 has a diameter of about 4 mm and is mounted slidingly to adjust to the bearing 21 of the guide support 2. The second guide part 32 is surmounted by an abutment 31 having a larger diameter than this second guide part 32. The needle 3 can be fabricated in stainless steel and have a weight of between approximately 4 and 6 grams. The needle 3 may have a height of between 30 and 50 mm. Those surfaces of the needle 3 guided in translation by the bearings 21 and 22 are advantageously polished to limit friction. Friction forces during translation of the needle 3 are advantageously less than 0.01 N.

Tests were conducted with a needle having the following dimensions:
a tip 34 provided with a free end of diameter 0.15 mm and height 0.8 mm, and provided with a junction part of diameter 0.3 mm and height 3.2 mm;
a first guide part 33 with a diameter of 1 mm and height of 17 mm;
a second guide part 32 having a first section of diameter 2.32 mm and height of 8.02 mm, and a second section of diameter 4 mm and height 8 mm;
an abutment 31 having a diameter of 8 mm and height of 8 mm.

Said needle 3 proved to be highly accessible and easily removable for cleaning

The centring accuracy of the needle 3 relative to the guide support 2, and the centring accuracy of the guide support 2 relative to the plate 4 allow a clearance to be maintained between the tip 34 and the through-hole of the associated reservoir. This clearance is preferably less than 100 μm. Suitable centring of the needle will allow the positioning of the deposit to be defined to an accuracy of 50 μm.

The device may comprise an agitator for the liquid sample to be deposited.

A lever 53 defines the translational stroke of the needles 3. This lever 53 is pivot mounted about two axes 51. The lever 53 is driven by a motor 52 associated with a cam. The cam has a projecting, offset part supporting the lever 53. During a rotation of the projecting part, the lever 53 is lowered under the effect of its own weight. It is also possible to use a ball bearing mounted in offset rotation relative to its axis, to limit wear. The motor 52 will limit the speed of descent of the needle 3 to around 10 to 20 mm per second. The motor 52 may be controlled so as to ensure a contact time between the tip 34 and the glass slide 6 of between 0.05 and 0.15 seconds. The contact time may notably be defined by the difference between the stroke of the end of the lever 53 and the stroke of the needle 3. In this embodiment, the needle 3 is driven downwards by its own weight. The lever 53 is then used to control the speed of descent of the needle 3. The lever 53 retains the needle 3 via the abutment 31. The lowering stroke of the lever 53 may continue beyond the contact between the tip 34 and the glass slide 6, the contact force then being solely defined by the weight of the needle 3, guaranteeing substantial regularity of the bearing force upon the glass slide 6. The translational stroke of the tip 34 may lie between 4 and 7 mm for example. The lever 53 holds the tip 34 in the reservoir 11 until a deposit order is given. When a deposit order is given, the lever 53 pivots to allow lowering of the tip 34 until it comes into contact with a glass slide 6. The tip 34 carries a drop of the solution 12 and deposits this drop on the glass slide 6. To raise the needle 3, the motor 52 continues its stroke to cause the lever 53 to pivot in opposite direction so that the needle 3 is driven upwards via the abutment 31.

According to one variant, it can be envisaged that the lever 53 is joined to the needle 3 via a spring. If the lever 53 is driven after the tip 34 has come into contact with the glass slide, the spring limits the contact force transmitted between the lever 53 and the tip 34.

According to another variant, the needle head rests on the lever 53 via a conical support, so that guiding of the needle is ensured by said lever 53, thereby obviating the need for the guide support 2.

The lowering of the needle 3 can be defined by other control mechanisms. Lowering may notably be defined via a stepper motor, via a cam converting a circular movement into a linear movement, via a rack or worm screw device. It is also possible to use a motor 52 of stepper type with origin locating. According to one variant, a motor 52 of asynchronous type is used with the same position locating.

FIG. 2 is a schematic overhead view of the formation 8 of deposits on glass slides 6, using a machine of the type detailed in FIG. 1. The deposition line 8 comprises a conveyor belt 7 travelling in a direction in which the glass slides 6 undergo treatments. The deposition line 8 comprises a device 81 placing glass slides 6 on the belt 7. The device 81 comprises actuating cylinders 82 placing the glass slides 6 on the belt 7 at regular intervals. A wash ramp 83 is arranged on the pathway of the glass slides 6 between the device 81 and the belt 7. A dryer device 84 is arranged downstream above the belt 7, so as to remove residual water deposited by the wash ramp 83 on the glass slides 6.

Further downstream, the deposition line 8 comprises several depositing machines 85 of the type detailed in the foregoing. Each depositing machine 85 comprises a lever 53 pivot-mounted about an axis 51 and a motor 52 controlling the lifting or lowering of the lever 53. Each lever 53 controls the lifting and lowering of six needles 3 aligned in the direction of travel of the conveyor, as detailed above. Directly under each deposit machine 85 and joined to said machine there is a template not shown in FIG. 2, which is used to block the slides in the exact position desired for deposition. The deposition line 8 may have the number of needles necessary to deposit different solutions on one slide 6. A control member 86 analyses the conformity of the deposits formed on the glass slides 6 downstream of the deposit machines 85. The control member 86 removes from the belt 7 those glass slides 6 considered to be nonconforming. Downstream of the control member 86, a handling device 87 comprises an actuating cylinder 88. The cylinder 88 places the glass slides 6 in a storage magazine 89 intended to receive a multitude of glass slides 6. The belt 7 is driven so as to move the glass slides 6 over incremented distances corresponding to the pitches between the plates 6. The conveyor belt 7 may be replaced by a rigid platform with teeth or notches, which takes and releases the slides in a cyclical movement, causing them to move a pitch, and depositing them in a fixed template where they are held in suitable position.

FIG. 3 is an overhead view of another embodiment of a deposit formation machine using standard diagnosis plates. Diagnosis plates 91 comprise 96 wells 92 distributed over eight lines and twelve columns with a pitch of 9 mm, as is standard. The diagnosis plates 91 are arranged on a conveyor 94 capable of driving them in direction X. The machine also comprises two rails 93 oriented along direction Y. A head 95 is slidingly mounted on the rails 93. A motor, not illustrated, positions the head 95 in direction Y. The head 95 carries a plurality of reservoirs and needles 3 which are guided and arranged in a 6×6 square array for example, a so-called chequer arrangement. The needles 3 illustrated by solid circles are lowered in vertical direction Z into the wells 92. The needles 3 illustrated by empty circles are not lowered into the wells. The arrangement of the needles and associated reservoirs reproduces the same pattern as the pattern to be followed for the micro-deposits at the bottom of the wells.

FIGS. 4a and 4b illustrate a needle 3 in two operating positions. In the position illustrated FIG. 4a, the tip 34 is housed inside the reservoir 11 and is dipped in the solution 12. In the position illustrated FIG. 4b, the tip 34 projects outside from the reservoir 11 and carries with it a fraction of solution 12 to form a micro-deposit on a support. The needle 3 is slidingly mounted in the guide support 2, in similar manner to FIG. 1. The guide support 2 in its lower part has a threaded bore. The reservoir 11 has an outer cylindrical shape. The outer surface of the reservoir 11 is threaded. The reservoir 11 is screwed into the threaded bore of the guide support 2. So that they can enter the wells 92, the reservoirs may have an outer diameter that is equal to or smaller than 8 mm. By allowing the lowering of the reservoir 11 into the well 92, it is possible to limit the necessary stroke of the tip 34 beyond the through-hole. The stroke of the tip 34 beyond the through-hole may be limited to 2 mm for example. The lower part of the guiding support 2 forms a shoulder 23 relative to the outer surface of the reservoir 11. This shoulder 23 is used as abutment to limit the lowering of the reservoir 11 inside an alveolus 92. The shoulder in which the lower bearing 22 is arranged forms a cover over the reservoir 11. The needle 3 has a bulge 35 capable of driving the upper shoulder when the needle 3 is raised. Therefore, by traction on the abutment 33, it is possible to extract the reservoir 11 from an alveolus 92. The needle 3, its guide and the through-hole may be slightly offset relative to the axis of the wells so as to obtain adequate spacing between the deposits.

FIG. 5 is a cross-sectional view of the machine at the wells 92 of a diagnosis plate 91. A deposit substrate such as a transparent sheet of glass or plastic 96 is arranged so that it lies against the bottom of the plate 91. The substrate 96 is surmounted by a grid in which the wells 92 are formed.

The machine has a control plate 54 provided with electromagnets 55a to 55e. The electromagnets 55a to 55e allow to hold or release the needles 3a to 3e, respectively. The upper end of the needles 3a to 3e is held by the control plate 54. In lowered position, the upper end of the needles 3a to 3e is supported by a command plate 56. The reservoirs of the needles 3b to 3e are then arranged in the wells 92. The upper part 97 of the grid lies at a predefined height, and forms an abutment for the shoulder 23 during lowering of the needles 3. The command plate 56 is mobile vertically between a top position illustrated by a dotted line, and a bottom position illustrated by a solid line. In its bottom position, the command plate 56 allows the needles to be lowered until a tip 34 protrudes from a through-hole of its reservoir and forms a deposit on the support 96.

The needle 3a is arranged outside the grid area, and its associated reservoir lies above a peripheral surface 98 of the plate 91. Also, needle 3a and needle 3e are held in raised position by the electromagnet 55a. The shoulder 23 of the guides for needles 3b to 3d lies in abutment against the upper part 97 of the squared plate.

The reservoir and the guide of these needles are therefore immobilized vertically. Since an order of lowering has been applied to the command plate 56, the tip 34 of the needles 3b to 3d projects outwardly from the reservoir and comes into contact with the substrate 96 so as to form a micro-deposit. As in the example in FIG. 1, the needles 3 come into contact with the substrate 96 under the effect of their own weight.

Assays were conducted with a reservoir having a diameter of 2 millimetres and height of 5 mm. 10 microlitres of bovine albumin solution labelled with aminomethylcoumarin were placed in this reservoir. A dead volume of four microlitres was maintained. The assays show reduced evaporation. This solution allowed the depositing of 6500 deposits without replenishing the reservoir. With no dead volume, said reservoir can therefore contain about 15 microlitres of solution and allow the forming of 10 000 deposits. FIG. 6 shows a blue fluorescence image of 81 deposits of BSA*AMCA, obtained with an excitation of 365 nm. It is noted that these deposits are fairly homogeneous with respect to each other, which confirms that the movement of the needle inside the reservoir maintains regular agitation of the solution. The intra-slide CV is between 10 and 13% (n=81%). The mean inter-slide CV is 5.62% (n=14).

From the mean fluorescence images of the deposits, the blue fluorescence of the sample micro-deposits, their standard deviation and CV are quantified for each slide under different assay conditions. It was notably ascertained that the use of different needles having weights varying from 6.48 g to 12.56 g did not induce any variation in the size or fluorescence of the deposits. It is therefore inferred that deposits can be formed under reduced pressure, which notably favours the cell depositing.

1. Device for forming micro-deposits of a liquid sample on a support, comprising:
a plurality of reservoirs for receiving a liquid sample to be deposited, a bottom of each reservoir being provided with a through-hole, the hole being sized to hold the sample in the reservoir under capillarity:
a plurality of needles, each needle being associated with a reservoir and having a tip mounted or movement as far as a position in which the tip passes through the hole and protrudes outwardly from the associated reservoir and to carry a fraction of the sample out of the reservoir; and
a control member controlling the movement of the tip as far as said position.

2. The device according to claim 1, wherein the tip is mounted for movement between a position in which the tip is housed inside the reservoir and said position in which the tip protrudes outwardly from the reservoir.

3. The device according to claim 1, wherein the hole is of circular shape and has a diameter of between 0.3 and 0.6 mm.

4. The device according to claim 3, wherein the tip has a diameter of between 0.10 mm and 0.3 mm.

5. The device according to claim 1, wherein the tip has several successive parts of increasing sectional diameters starting from a free end of the tip.

6. The device according to claim 1, wherein each reservoir has a capacity of between 5 and 100 microlitres.

7. The device according to claim 1, wherein each reservoir has a cylindrical bore in an upper part, and a conical bore in a lower part joining the cylindrical bore to the through-hole.

8. The device according to claim 1, wherein an outer part of the reservoir surrounding the through-hole is coated with a hydrophobic coating.

9. The device according to claim 2, wherein weight of the needle drives the tip towards the position in which the tip protrudes outwardly from the reservoir, and wherein the control member comprises a motor and a lever actuated by the motor driving the needle towards the position in which the tip is housed inside the reservoir.

10. The device according to claim 9, wherein the reservoirs are spaced apart by one same pitch and the lever drives the tip of each needle towards the position in which the tip is housed inside the associated reservoir.

11. The device according to claim 1, wherein all reservoirs are arranged in one same single-piece component.

12. The device according to claim 1, further comprising a guide, joined to the reservoir, and wherein the needle comprises a body projecting beyond and joined to the tip, the body being guided in translation by the guide.

13. The device according to claim 12, wherein the reservoir has an outer wall of cylindrical shape screwed into a lower bore of the guide.

14. The device according to claim 13, wherein the guide forms a shoulder projecting radially beyond the outer wall of the reservoir.

15. The device according to claim 12, wherein the needle has a bulge projecting radially inside the guide under a bearing.

16. The device according to claim 1, in combination with:
a support which the wells are arranged; and
wherein the control member comprises a raising-lowering device for causing the needles to enter the wells;
said plurality of needles and the support being subjected to relative perpendicular movements.

17. The device according to claim 16, wherein said plurality of needles and associated reservoirs is arranged so as to reproduce a pattern of the micro-deposits to be formed during movement of the support or of the needles.

18. The device according to claim 1, wherein said plurality of needles comprises 2 to 50 needles and associated reservoirs, said needles and associated reservoirs being arranged in a geometric array.

19. The device according to claim 1, further comprising a member to place and remove a support directly under the tip.

20. The device according to claim 1, in combination with:
a conveyor conveying supports in a direction of treatment;
a loading device to load the supports on the conveyor;
the device for forming micro-deposits being arranged directly above the supports placed on the conveyor downstream of the loading device, the device forming micro-deposits on the supports in a manner synchronized with travel on the conveyor; and
an unloading device unloading a support from the conveyor, arranged downstream of the device for forming micro-deposits.

21. Method for forming micro-deposits of a liquid sample on a support, comprising application of the micro-deposits by a device according to claim 1.

22. The device according to claim 6, wherein each reservoir has a capability of between 5 and 50 microlitres.

23. The device according to claim 18, wherein the geometric array comprises a square or a rectangle.
